(19) United States
(12) Patent Application Publication
(10) Pub. No.: US 2008/0028378 A1
(43) Pub. Date: Jan. 31, 2008

(54) UTILIZING PRIOR USAGE DATA FOR SOFTWARE BUILD OPTIMIZATION

(75) Inventors: Surupa Biswas, Redmond, WA (US); Ori Gershony, Redmond, WA (US); Jonathan P. de Halleux, Seattle, WA (US); Jiyang Liu, Redmond, WA (US); Brian F. Sullivan, Woodinville, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/460,577

(22) Filed: Jul. 27, 2006

(51) Int. Cl. G06F 9/45; G06F 9/44

(52) U.S. Cl. 717/151; 717/101

(57) ABSTRACT

In one embodiment, a computer system packages a first set of data objects into a first software build. The computer system evaluates at least a portion of the usage of the first software build in accordance with usage training scenarios. The computer system monitors the evaluation of the first software build in accordance with a first software build usage detection process to detect the use of data objects within the first software build. The computer system generates profile data for the data objects and the generated profile data includes an indication of usage for each data object. The computer system packages a second set of data objects into a second software build in accordance with the generated profile data from the first software build, wherein the second set of data objects is different from but includes one or more data objects from the first set of data objects.

### BACKGROUND

Computers are used all over the world to accomplish a variety of tasks. Computers accomplish tasks by processing sets of instructions derived (e.g., compiled or interpreted) from software source code. Software source code is typically written by a software developer using one or more programming languages. Most programming languages have a software source code compiler that allows the code to be compiled into one or more executable files. A number of executable files can be used in conjunction with one another to form a software application. As such, software applications can be viewed as conglomerates of executable files, where each executable file may be initiated by the user or by the software application to perform, or assist in performing a task.

During application development process, software developers often make multiple revisions to the software source code. Each time the source code is revised and re-compiled, a new version of one or more executable files is created. Large software applications may have thousands of executable files, each of which may be revised and re-compiled a number of times during the development process. Because of the complex interactions of executable files within an application, the application must be thoroughly tested to ensure that the intended functionality is working as expected.

In many cases, actual use of a software application is unique to each user. Many times, users of software applications will not use all of the available functions proportionately. For example, some of the lesser-known functions in an application may only be used periodically whereas more well-known features may be used nearly every time the application is opened. In some cases, the developer of the application might have a good idea of the features that are going to be used extensively by most of the application users. In that case he/she can optimize the application's performance for those specific usage patterns. However this optimization process involves running the various common usage scenarios as part of the application build process. Running these scenarios every time a new build of the application has to be generated is both time-intensive and costly.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments of the present invention are directed to systems, methods, and computer program products for utilizing prior usage data for software build optimization. In one embodiment of this invention, a computer system performs a method for optimizing the processing of a set of data objects. The method involves the computer system packaging a first set of data objects into a first software build. The computer system evaluates at least a portion of the usage of the first software build in accordance with usage training scenarios. The computer system monitors the evaluation of the first software build in accordance with a first software build usage detection process to detect the use of data objects within the first software build. The computer system generates profile data for the data objects and the generated profile data includes an indication of usage for each data object. The computer system packages a second set of data objects into a second software build in accordance with the generated profile data from the first software build, wherein the second set of data objects is different from but includes one or more data objects from the first set of data objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a computing environment in which embodiments of the present invention may operate including utilizing prior usage data for software build optimization;

FIG. 2 illustrates a flowchart of a method for utilizing prior usage data for software build optimization; and

FIG. 3 illustrates a flowchart of an embodiment of a method for utilizing prior usage data for software build optimization.

### DETAILED DESCRIPTION

Embodiments of the present invention are directed to systems, methods, and computer program products for utilizing prior usage data for software build optimization. In one embodiment of this invention, a computer system performs a method for optimizing the processing of a set of data objects. The method involves the computer system packaging a first set of data objects into a first software build. The computer system evaluates at least a portion of the usage of the first software build in accordance with usage training scenarios. The computer system monitors the evaluation of the first software build in accordance with a first software build usage detection process to detect the use of data objects within the first software build. The computer system generates profile data for the data objects and the generated profile data includes an indication of usage for each data object. The computer system packages a second set of data objects into a second software build in accordance with the generated profile data from the first software build, wherein the second set of data objects is different from but includes one or more data objects from the first set of data objects.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired and wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

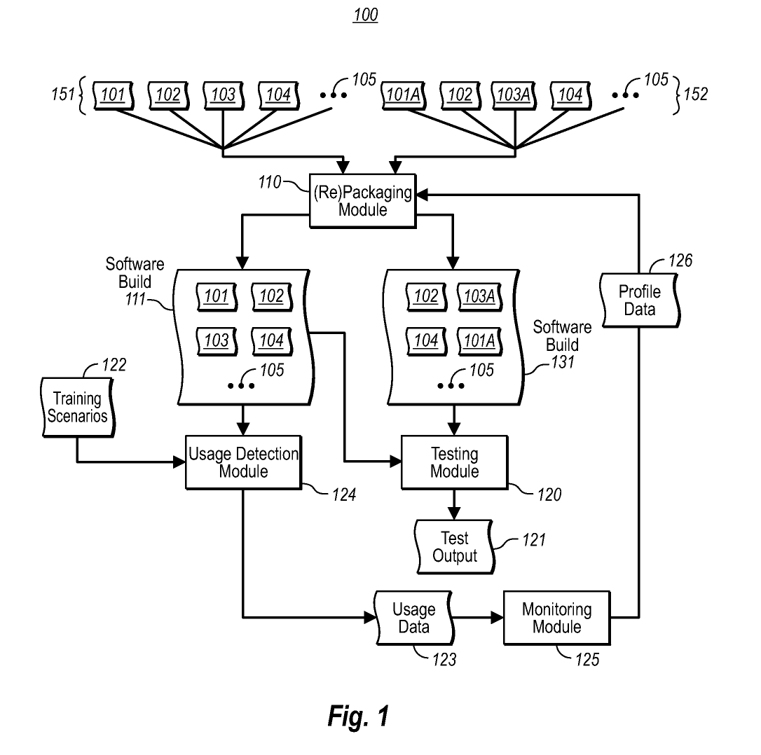

FIG. 1 illustrates an environment 100 (e.g., a computer architecture) in which the principles of the present invention may be employed. The environment 100 includes a first set of data objects 151, including data objects 101, 102, 103, 104, and 105 and a second set of data objects 152, including 101A, 102, 103A, 104 and 105. Set 151 and 152 can represent different versions of the same software application. Set 152 can include objects having subsequent modifications from objects in set 151. For example, objects 101A and 103A can be modified versions of objects 101 and 103. Data objects are items of information recognizable by a computer system. In some embodiments, data objects may be strings, threads, files (of any type), software source code or any other computer-readable information. The horizontal ellipses 105 represents that the environment 100 may include even more than the illustrated four data objects (101-104). However, embodiments with fewer data objects are also possible.

FIG. 1 also includes a (re)packaging module 10. In some embodiments, a (re)packaging module 110 may be used to package data objects into a software assembly or software build, such as, for example, software builds 111 and 131 (e.g., different builds of the same software application). A software build is a conglomeration of data objects designed to work together to perform functions in a software application. For example, (re)packaging module 110 can build set 151 into software build 111 and can build set 152 into software build 131.

A software application is a program that allows a user to interface with and perform one or more tasks on a computer system. Once instantiated, software applications perform functions and each function may utilize one or more data objects (e.g., 101-105) in the performance of a function. A software build (e.g., 111 and 131) can comprise one or more applications.

In some embodiments, (re)packaging module 110 may also be capable of repackaging one or more data objects based on generated profile data 126. The (re)packaging module 110 may package the data objects of set 152 (101A, 102, 103A, 104 and 105) in any order: in some instances, the data objects may be packaged in the same order as in software build 111 (as shown in software build 131); in other cases, the data objects may be packaged in an order different from software build 111. Data objects 101A and 103A indicate that these data objects are modified forms of data objects 101 and 103, respectively. The data objects may have been modified by one or more developers, as explained above. In some embodiments, the (re)packaging module 110 repackages the second set of data objects (e.g., 101A-105) according to the profile data 126 received from the monitoring module 125.

FIG. 1 also includes a usage detection module 124. In some embodiments, the usage detection module 124 may be used to detect which data objects are used during a training scenario 122. In some embodiments, training scenarios 122 may be tests used to evaluate how a user uses the software application comprised in build 111. The training scenarios 122 provide plausible scenarios of typical application use by a user. The usage detection module 124 may be configured to output usage data 123. Usage data 123 may be information that includes, for example, each function call, each opening of a data object, each time a data object is accessed, transferred, copied or otherwise used in any way during the training scenarios 122. (Re)packaging module 110 can repackage a set 152 (e.g., 101A-105) into build 131 according to the degree of use of objects in software build 111.

FIG. 1 also includes a testing module 120. In some embodiments, the testing module 120 evaluates at least a portion of the functionality of a software build. For example, in cases where a software build 111 comprises one application, that application may be tested to determine whether the designed functionality is working as expected. Upon completion of a test, the testing module 120 may output a test output 121. In some embodiments, the test output 121 may be a summary of the test results, or, in other embodiments, it may be a full report of the test results, detailing the result of each test action.

FIG. 1 also includes a monitoring module 125. While the usage detection module 124 is evaluating the data object usage within a software build 111, the monitoring module 125 may be used to monitor the evaluation of the software build 111. The monitoring module 125 may be capable of observing a software build training scenario and detecting use of data objects (101-105) within the software build 111. For example, a usage detection module 124 may initialize and call different functions within an application to evaluate how they perform. The monitoring module 125 monitors the use of each object, such as, for example, each function call, each opening of a data object, each time a data object is accessed, transferred, copied or otherwise used in any way. The monitoring module 125 may receive such information in the form of usage data 123 from the usage detection module 124. Continuing this example, the monitoring module 125 may store a record of each data object used; such a record may be referred to as profile data 126. Profile data 126 may include information regarding how the data object was used, when it was used, what function called it, how long it was used, or any other determination of use.

In some embodiments, (Re)packaging module 110 may be capable of packaging one or more data objects (101A-105) that have been previously packaged. The (re)packaging module 110 may package the data objects (101A-105) in any order: in some instances, the data objects may be packaged in the same order as in software build 111; in other cases, the data objects may be packaged in an order different from software build 111. In some embodiments, the (re)packaging module 110 repackages set 152 (101A-105) according to the profile data 126 (generated from monitoring the use of software build 111) received from the monitoring module 125. In this manner, the (re)packaging module 110 may package set 152 (101A-105) according to use during the training scenarios 122.

In some cases, build 131 may be tested using the profile data collected from training scenarios 122. For example, software build 111 can be put through one or more training scenarios 122, and the usage data 123 gathered by the usage detection module 124. Usage data 123 can be recorded by the monitoring module 125 as profile data 126, the (re)packaging module may package set 152 (101A-105) according to profile data 126.

Additionally or alternatively, the testing module 120 may test software build 131 for functionality based on the profile data 126 gathered for build 111. In this manner, each new build may avoid going through training scenarios 122 because the usage data 123 is reused. This can potentially save large amounts of time and computing power. Optionally, a new software build may be sent through the training scenarios 122 and the profile data 126 may be modified according to the usage data objects in the new build.

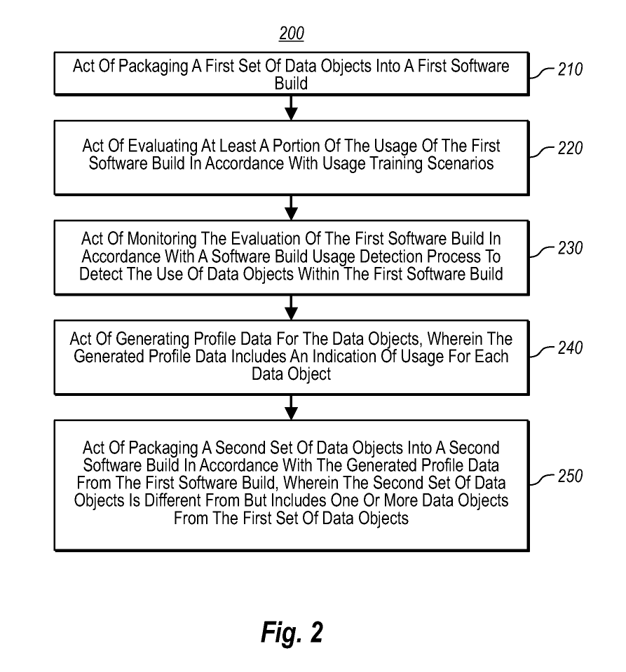

FIG. 2 illustrates a flowchart of a method 200 for utilizing prior usage data for software build optimization. The method 200 will now be described with frequent reference to the components and data of environment 100.

Method 200 includes an act of packaging a first set of data objects into a first software build (act 210). For example, a (re)packing module 110 may package a set 151 (101-105) into a first software build 111. Packaging, as used herein, refers to combining or compiling data objects into a group or conglomerate of data objects. The conglomerate of data objects can be referred to as a software build 111, as explained above.

Method 200 also includes an act of evaluating at least a portion of the usage of the first software build in accordance with usage training scenarios (act 220). For example, a testing module 120 may evaluate at least a portion of the usage of software build 111 in accordance with training scenarios 122. In some embodiments, training scenarios 122 include one or more usage scenarios that usage detection module 124 can use to evaluate at least a portion of the usage of binaries in software build 111 caused by running application commands, calling functions, executing code paths, loading and unloading processes, or using other means of activating software build functionality. Thus, training scenarios 122 can exercise important and/or more common code-paths in software build 111 and record what portions of the application's binaries (e.g., data objects 101-105) get touched when those code-paths are exercised. For example, every use of software build 111 will have to launch software build 111 in order to use software build 111. As such, training scenarios 122 can include a usage scenario to detect binary usage when software build 111 is launched.

Method 200 also includes an act of monitoring the evaluation of the first software build in accordance with a usage detection process to detect the use of data objects within the first software build (act 230). For example, monitoring module 125 may monitor the evaluation of the first software build 111 in accordance with a software build usage detection process to detect the use of data objects (101-105) within the first software build 111.

In some embodiments, monitoring module 125 may monitor the evaluation of a first software build 111, as explained above, and record each time a function or piece of source code or data object is used. These records are referred to herein as profile data, as explained below.

The method of FIG. 2 also includes an act of generating profile data for the data objects, wherein the generated profile data includes an indication of usage for each data object (act 240). For example, monitoring module 125 may generate profile data 126 for data objects (101-105) and include in the profile data 126 an indication of as usage for each data object. In some embodiments, it may be advantageous to determine which data objects in a build were used in the training scenarios 122 and use that profile data for optimizing the (e.g., subsequently) generated software build.

In some embodiments, the profile data 126 may include block offsets or block weights. Blocks are portions of software source code. In some cases, the act of monitoring the evaluation of the first software build in accordance with a software build usage detection process to detect the use of data objects within the first software build (act 230) monitors and stores information indicating the number of times that particular portion of source code was executed during the usage detection process. The number of times the block was executed during the usage detection process is referred to herein as the block weight.

In some embodiments, profile data may additionally or alternatively include metadata tokens. Metadata tokens are identifiers which may be used to identify functions or data structures within software source code. Metadata tokens may also be used to identify references to functions within builds of other applications. Furthermore, metadata tokens may be used to identify which data structures have been called or executed during a software build usage detection process. In some embodiments, during the act of monitoring the evaluation of the first software build in accordance with a software build usage detection process to detect the use of data objects within the first software build (act 230), monitoring module 125 may monitor metadata tokens that are configured to indicate which functions were executed during the software build usage detection process.

In some embodiments, profile data may additionally or alternatively include blobs. Blobs are identifiers capable of identifying generic methods in a software build. In some cases, blobs may be signatures for generic methods. Additionally or alternatively, blobs may include metadata strings, or strings of identifiers such as metadata tokens. In some embodiments, during monitoring, monitoring module 125 may monitor blobs that indicate which generic methods were executed during the software build usage detection process. The blobs may also identify other identifiers such as metadata tokens that indicate which functions or sections of source code were executed during the software usage detection testing process.

In some embodiments, profile data includes information indicating which Common Language Runtime (CLR) data structures were referenced during the software build usage detection process. These CLR data structures may be identified by metadata tokens or blobs, as described above. Moreover, in some embodiments, profile data may include at least one of block weights, metadata tokens or blobs indicating which code paths were executed during the software build usage detection process. In some cases, the executed code paths may be mapped and stored and are thus available for use in repackaging a build, as explained below.

Method 200 also includes an act of packaging the second set of data objects into a second software build in accordance with the generated profile data from the first software build, wherein the second set of data objects is different from but includes one or more data objects from the first set of data objects (act 250). For example, (re)packing module 110 can repackage set 152 (101A-105) into software build 131 based on profile data 126. In some embodiments, usage data 123 is packaged with the generated build 131 so that the usage data 123 can be used to optimally lay out the code/CLR data structures in the binary at application run-time. Each data object (101-105) that was accessed during the training scenarios 122 is considered “hot” and all “hot” data objects are packaged together. All other data objects are placed in a “cold” section. The idea is that if only data objects or code from the hot section are required at application runtime, then everything required can be accessed by touching very few pages on the hard-disk (the cold section pages have been sifted out, and hence do not need to be accessed). In some cases, this may lead to significant application start-up time and working set size improvements.

In some embodiments, the act of packaging the second set of data objects in accordance with the generated profile data comprises mapping the metadata tokens from a first version of the software build to a second version of the software build. As explained above, metadata tokens may identify which portions of source code were executed during the software build usage detection process. The metadata tokens of the first version of a software build (i.e. build 111) may be mapped and stored during the software build usage detection process. Next, the mapped metadata tokens may be used by the repackaging module 110 to repackage the second set of data objects (i.e. build 131) according to which functions and/or portions of source code were identified by the metadata tokens. Furthermore, in some embodiments, basic block weights for the code are mapped from build 111 to 131 by analyzing the basic block graphs (sometimes referred to as Control Flow Graphs) for the two builds (111 and 131) and doing a best-effort job of transferring block weights from one graph to the other.

Optionally, in some embodiments, the computer system may evaluate at least a portion of the functionality of any data objects in the second software build using profile data generated from the first software build. For example, testing module 120 can evaluate the functionality of software build 131 using profile data 126 generated from build 111.

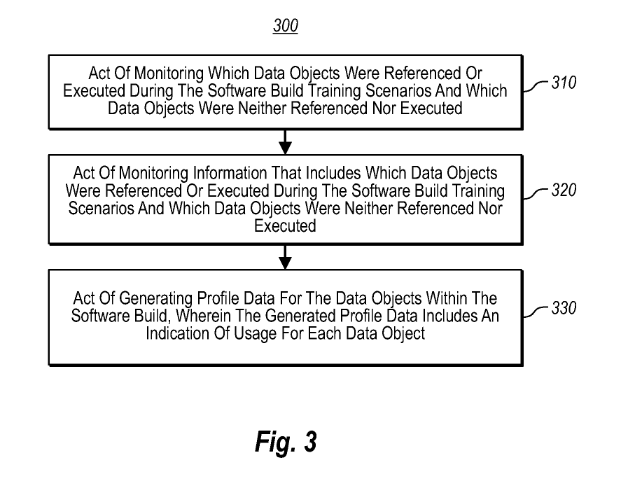

FIG. 3 illustrates a flowchart of an alternative method 300 for optimizing a software build testing process. The method 300 will now be described with frequent reference to the components and data of environment 100.

The method of FIG. 3 includes an act of monitoring which data objects were referenced or executed during the software build testing scenarios and which data objects were neither referenced nor executed (act 310). For example, monitoring module 125 may monitor which data objects (101-105) were referenced or executed during the software build training scenarios related to software build 111 and which data objects (101-105) were neither referenced nor executed. Data objects may include strings, threads, files (of any type) or any other computer-readable information, as explained above.

The method of FIG. 3 includes an act of monitoring information that includes which data objects were referenced or executed during the software build training scenarios and which data objects were neither referenced nor executed (act 320). For example, monitoring module 125 can monitor usage data 123 that includes which data objects were referenced or executed during the software build training scenarios and which data objects were neither referenced nor executed. Usage data 123 can also indicate how many times a data object was referenced or executed. In some embodiments, usage data 123 may include block weights, metadata tokens, and/or blobs.

The method of FIG. 3 includes an act of generating profile data for the data objects within the software build, wherein the generated profile data includes an indication of usage for each data object (act 330). For example, monitoring module 125 may generate profile data 126 for the data objects (101-105) within software build 111 based on usage data 123. In some embodiments, profile data 126 may include an indication of usage for each data object. Such profile data 126 may be used in the evaluation of subsequent software builds, as explained above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system that is configured to process data objects, a method for utilizing prior usage data for software build optimization, the method comprising the acts of:
packaging a first set of data objects into a first software build;
evaluating at least a portion of the usage of the first software build in accordance with usage training scenarios;
monitoring the evaluation of the first software build in accordance with a software build usage detection process to detect the use of data objects within the first software build;
generating profile data for the data objects, wherein the generated profile data includes an indication of usage for each data object; and
packaging a second set of data objects into a second software build in accordance with the generated profile data from the first software build, wherein the second set of data objects is different from but includes one or more data objects from the first set of data objects.

2. The method of claim 1, wherein the profile data includes block weights indicating the number of times a block of code was executed during the software build usage dection process.

3. The method of claim 2, wherein block weights are mapped from the first software build to the second software build by analyzing basic block graphs for the first and the second builds and transferring block weights from one graph to the other.

4. The method of claim 1, wherein the profile data comprises metadata tokens which are capable of identifying functions or data structures within software source code.

5. The method of claim 4, wherein the act of packaging a second set of data objects in accordance with the generated profile data comprises mapping the metadata tokens from a first version of the software build to a second version of the software build.

6. The method of claim 1, wherein the profile data comprises blobs which are capable of identifying generic methods used in a software build.

7. The method of claim 1, wherein the usage training scenarios comprise one or more software build tests that the computer system uses to evaluate at least a portion of the functionality of the first software build by running application commands, calling functions, executing code paths, loading and unloading processes, or using other means of activating software build functionality.

8. The method of claim 1, further comprising evaluating at least a portion of the functionality of any data objects in the second software build using profile data generated from the first software build.

9. The method of claim 1, wherein profile data includes information indicating which Common Language Runtime (CLR) data structures were referenced during the software build usage dection process.

10. A computer program product for use at a computer system, the computer program product of implementing a method for utilizing prior usage data for software build optimization, the computer program product comprising one or more computer-readable storage media having stored thereon computer-executable instructions that, when executed by one or more processors of the computer system, cause the computer system to perform the following:
package a first set of data objects into a first software build;
evaluate at least a portion of the usage of the first software build in accordance with usage training scenarios;
monitor the evaluation of the first software build in accordance with a software build usage detection process to detect the degree of use of data objects within the first software build;
generate profile data for the data objects, wherein the generated profile data includes an indication of usage for each data object; and
package a second set of data objects into a second software build in accordance with the generated profile data from the first software build, wherein the second set of data objects is different from but includes one or more data objects from the first set of data objects.

11. The method of claim 10, wherein the profile data includes block weights indicating the number of times a block of code was executed during the software build usage detection process.

12. The method of claim 11, wherein block weights are mapped from the first software build to the second software build by analyzing basic block graphs for the first and the second builds and transferring block weights from one graph to the other.

13. The method of claim 10, wherein the profile data comprises metadata tokens which are capable of identifying functions or data structures within software source code.

14. The method of claim 13, wherein the act of packaging a second set of data objects in accordance with the generated profile data comprises mapping the metadata tokens from a first version of the software build to a second version of the software build.

15. The method of claim 10, wherein the profile data comprises blobs which are capable of identifying generic methods used in a software build.

16. The method of claim 10, wherein the usage training scenarios comprise one or more software build tests that the computer system uses to evaluate at least a portion of the functionality of the first software build by running application commands, calling functions, executing code paths, loading and unloading processes, or using other means of activating software build functionality.

17. The method of claim 10, further comprising evaluating at least a portion of the functionality of any data objects in the second software build using profile data generated from the first software build.

18. The method of claim 10, wherein profile data includes information indicating which Common Language Runtime (CLR) data structures were referenced during the software build usage detection process.

19. At a computer system configured to process data objects, a method for optimizing the processing of a set of data objects by incorporating profile data from software build training scenarios from a first version of a software build to a second version the software build, the method comprising the acts of:
monitoring which data objects were referenced or executed during the software build training scenarios and which data objects were neither referenced nor executed;
monitoring information that includes which data objects were referenced or executed during the software build training scenarios and which data objects were neither referenced nor executed; and
generating profile data for the data objects within the software build, wherein the generated profile data includes an indication of usage for each data object.

20. The method of claim 19, wherein the indication of usage includes at least one of block weights indicating the number of times a block of code was executed during the software build training scenarios, metadata tokens which are capable of identifying functions or data structures within software source code, or blobs which are capable of identifying generic methods used in a software build.
